(19) United States
(12) Patent Application Publication
(10) Pub. No.: US 2012/0207942 A1
(43) Pub. Date: Aug. 16, 2012

(54) PROCESS FOR PRODUCTION OF LIQUID CRYSTAL DISPLAY DEVICE

(76) Inventor: Minoru Takagi, Osaka-shi (JP)

(21) Appl. No.: 13/502,425

(22) PCT Filed: Jul. 22, 2010
(86) PCT No.: PCT/JP2010/062315

§ 371 Date: Apr. 17, 2012

(30) Foreign Application Priority Data
Nov. 9, 2009 (JP) 2009-256331

(51) Int. Cl. C08J 7/18

(52) U.S. Cl. 427/514

(57) ABSTRACT

The present invention provides a process for producing a semi-transmissive liquid crystal display device which allows sufficient polymerization reaction in the liquid crystal layer in each of the reflection region and the transmission region. The process is a process for producing a liquid crystal display device that includes a pair of substrates consisting of a color filter substrate including a transparent colored layer and a counter substrate including a reflector, and a liquid crystal layer sandwiched by the pair of substrates, the process including a first step of placing a liquid crystal material containing a polymerizable compound between the pair of substrates, and a second step of forming, on a surface of each of the pair of substrates, a polymer layer resulting from polymerization of the polymerizable compound by irradiating the liquid crystal layer with light from the counter substrate side and from the color filter substrate side while applying a voltage not lower than a threshold value to the liquid crystal layer, the irradiation from the color filter substrate side being performed by causing light having passed through the pair of substrates to be reflected on a ridged surface of a reflective stage that is arranged on an outer side of the color filter substrate.

### TECHNICAL FIELD

The present invention relates to a process for producing a liquid crystal display device. More specifically, the present invention relates to a process for producing a liquid crystal display device which includes a step of forming a polymer layer on an alignment film.

### BACKGROUND ART

A liquid crystal display (LCD) is a display device that controls transmission/blocking of light (ON/OFF of display) by controlling the alignment of liquid crystal molecules having birefringence. LCDs employ display modes such as a vertical alignment (VA) mode in which liquid crystal molecules having negative dielectric anisotropy are aligned vertically to the substrate surface, and an in-plane switching (IPS) mode in which liquid crystal molecules having positive dielectric anisotropy are aligned horizontally to the substrate surface.

LCDs can be classified into transmissive LCDs including a separate backlight source of which the light is used for display, and reflective LCDs including a reflector instead of a backlight source so that surrounding light is used for display. Specific examples of the backlight source include reflecting components, diffusion components, and light controlling components with ridges, as well as light sources (for example, Patent Document 1).

However, both the transmissive LCDs and the reflective LCDs have advantages and disadvantages. For example, a backlight source is necessary for stable display, but the power consumption definitely increases if the backlight is the only light source. To solve such a problem, semi-transmissive LCDs have been proposed each of which provides transmissive-type display and reflective-type display on a single liquid crystal panel using a transmissive region and a reflective region which are provided for each pixel (for example, Patent Documents 2 and 3).

Also in recent years, use of a pretilt-angle providing technique employing a polymer has been proposed as a method of producing an LCD that provides high luminance and fast response (for example, Patent Documents 4 to 7). In the pretilt-angle providing technique employing a polymer, a liquid crystal composition containing a mixture of polymerizable components such as polymerizable monomers and oligomers is placed between substrates. Then, the monomers are polymerized while a voltage is applied between the substrates to tilt (incline) the liquid crystal molecules, so that a polymer is formed. This technique produces liquid crystal molecules tilted at a predetermined pretilt angle even after the voltage application is terminated, giving a certain alignment direction to the liquid crystal molecules. The monomers are selected from a material polymerizable by heat, light (ultraviolet light), or the like. The liquid crystal composition sometimes contains a polymerization initiator for initiating the polymerization reaction of monomers.

Patent Document 1: JP 2009-123504 A

Patent Document 2: JP 2003-50389 A

Patent Document 3: JP 2009-139814 A

Patent Document 4: JP 2003-177418 A

Patent Document 5: JP 2003-149647 A

Patent Document 6: JP 2005-173439 A

Patent Document 7: JP 2005-338472 A

### SUMMARY OF THE INVENTION

The present inventor has made various studies on application of the pretilt-angle providing technique, employing polymerizable components such as polymerizable monomers and oligomers, to semi-transmissive liquid crystal display devices. As a result, the present inventor has found that it is difficult to sufficiently react the polymerizable components to form a polymer layer by simply irradiating the liquid crystal display panel with light.

FIG. 3 and FIG. 4 are for explaining a conventional process of applying a pretilt-angle providing technique with a polymerizable component to a semi-transmissive liquid crystal display device. FIG. 3 illustrates a state before light irradiation, and FIG. 4 illustrates a state after the light irradiation from the array substrate side. As illustrated in FIG. 3 and FIG. 4, a semi-transmissive liquid crystal display device usually includes a pair of substrates consisting of a color filter substrate 110 including a color filter 112 and a counter substrate 120 including a reflector 122. In the device, a region not overlapping the reflector 122 is a transmissive region T, and a region overlapping the reflector 122 is a reflective region R.

Here, alignment control of liquid crystal molecules 131 in a liquid crystal layer 130 formed between the color filter substrate 110 and the counter substrate 120 enables to control the ON and OFF states of display in the liquid crystal display device.

The color filter 112 is provided with a red colored filter 112R, a green colored filter 112G, and a blue colored filter 112B. The color filter substrate 110 also includes an insulating transparent substrate 111 (e.g., glass, plastics), a multi-gap layer 113, and an alignment film 114, as well as the color filter 112. The multi-gap layer 113 is formed in the reflective region R.

The counter substrate 120 including the reflector 122 is provided with an insulating transparent substrate 121 (e.g., glass, plastics) and an alignment film 123.

As illustrated in FIG. 3, the liquid crystal layer 130 includes monomers 132 as well as the liquid crystal molecules 131 before light irradiation. Upon irradiation of the liquid crystal layer 130 with light for polymerization reaction of the monomers 132 (the light indicated by outlined arrows in FIG. 4), the monomers 132 are polymerized, and thereby a polymer layer 133 is formed on the surfaces of the alignment films 114 and 123 which are respectively provided for the color filter substrate 110 and counter substrate 120. Such a process enables to give a desired pretilt angle to the liquid crystal molecules 131.

Here, there are two possible methods for light irradiation, namely irradiation from the counter substrate 120 side as illustrated in FIG. 4 and irradiation from the color filter substrate 110 side.

However, in the case of light irradiation from the counter substrate 120 side as illustrated in FIG. 4, the light is blocked by the reflector 122. Accordingly, a polymer layer is not easily formed in the reflective region R, which leads to insufficient pretilt. Therefore, the liquid crystal molecules 131 in the reflective region R remain vertically aligned.

Meanwhile, in the case of light irradiation from the color filter substrate 110 side, the light is absorbed by the color filter 112, and therefore the pretilt tends to be insufficient in both the transmissive region T and the reflective region R.

In the case of separately performing these two methods, a new problem of an increase in the number of production steps arises.

The present invention has been made in view of the above state of the art, and aims to provide a process for producing, through a small number of steps, a semi-transmissive liquid crystal display device which allows sufficient polymerization reaction in the liquid crystal layer in both the reflective region and the transmissive region.

The present inventor has made various studies on processes for causing sufficient polymerization reaction in the reflective region even in the case of performing the light irradiation from the counter substrate side. As a result, the present inventor has found that light can be introduced into the reflective region by arranging a reflective stage having a ridged surface on the backside of the color filter substrate, with the counter substrate side taken as the observation side, to allow the light to be reflected on the surface of the reflective stage for random reflection.

That is, the present invention relates to a process for producing a liquid crystal display device that includes a pair of substrates consisting of a color filter substrate including a transparent colored layer and a counter substrate including a reflector, and a liquid crystal layer sandwiched by the pair of substrates, the process including a first step of placing a liquid crystal material containing a polymerizable compound between the pair of substrates, and a second step of forming, on a surface of each of the pair of substrates, a polymer layer resulting from polymerization of the polymerizable compound by irradiating the liquid crystal layer with light from the counter substrate side and from the color filter substrate side while applying a voltage not lower than a threshold value to the liquid crystal layer, the irradiation from the color filter substrate side being performed by causing light having passed through the pair of substrates to be reflected on a ridged surface of a reflective stage that is arranged on an outer side of the color filter substrate.

The liquid crystal display device includes a pair of substrates consisting of a color filter substrate including a transparent colored layer and a counter substrate including a reflector, and a liquid crystal layer sandwiched by the pair of substrates. Providing a reflector to the counter substrate allows the outdoor light to be used for display light. A region in which the light reflected on the reflector is used for display as above is also referred to as a reflective region. A region in which the light used for display light is not the light reflected on the reflector but transmitted light from a light source such as a backlight is also referred to as a transmissive region. That is, the liquid crystal display device produced by the production process of the present invention is a semi-transmissive liquid crystal display device. In the reflective region, a circular polarizer including a λ/4 retarder is arranged on the color filter substrate side such that the outdoor incident light can be circularly polarized. By utilizing the difference in the polarization states between the incident light and the reflected light which pass through the liquid crystal layer, good display can be achieved in the reflective region.

The control mode for the liquid crystal layer in the liquid crystal display device of the present invention may be any control mode such as the twisted nematic (TN) mode, the VA mode, and the IPS mode. The control mode also may be the multi-domain vertical alignment (MVA) mode in which one or both of the substrates has/have protrusions (dielectric components) or slits in the electrodes, and this mode enables to provide a wide viewing angle.

The counter substrate can control the liquid crystal alignment in each pixel by having a pixel electrode, for example. The color filter substrate can control the display color of each pixel in the case that the substrate has colored filters of R (red), G (green), B (blue) and the like each at a place overlapping with a single pixel electrode of the counter substrate, for example.

The production process includes a first step of placing a liquid crystal material containing a polymerizable compound between the pair of substrates. Placing the liquid crystal material containing a polymerizable compound (e.g., polymerizable monomers and oligomers) between the color filter substrate and the counter substrate results in formulation of a liquid crystal layer. The polymerization reaction of the polymerizable compound is not particularly limited as long as polymerization is initiated by light irradiation. The polymerization reaction includes both of the following reactions: “step-growth polymerization” in which the molecular weight of bifunctional monomers increases through stepwise formation of new bonds; and “chain polymerization” in which monomers bond to an activated species generated from a small amount of a catalyst (initiator) to grow in chains. Examples of the step-growth polymerization include polycondensation and polyaddition. Examples of the chain polymerization include radical polymerization and ionic polymerization (e.g., anionic polymerization, cationic polymerization).

The production process includes a second step of forming, on a surface of each of the pair of substrates, a polymer layer resulting from polymerization of the polymerizable compound by irradiating the liquid crystal layer with light (1) from the counter substrate side (irradiation from this side is also referred to as “first irradiation”) and (2) from the color filter substrate side (irradiation from this side is also referred to as “second irradiation”) while applying a voltage not lower than a threshold value to the liquid crystal layer, the irradiation from the color filter substrate side being performed by causing light having passed through the pair of substrates to be reflected on a ridged surface of a reflective stage that is arranged on an outer side of the color filter substrate.

The first irradiation introduces light directly into the transmissive region, thereby allowing the polymerization reaction to proceed sufficiently in the region irradiated with the light, i.e., the transmissive region.

The second irradiation introduces the reflected light into the transmissive region again, and also introduces the reflected light into the reflective region. Hence, polymerization reaction initiated by the first irradiation and polymerization reaction initiated by the second irradiation proceed in the transmissive region, and polymerization reaction initiated by the second irradiation proceeds in the reflective region, which means that it takes only one step to provide a pretilt angle to both of the transmissive region and the reflective region, with use of a polymerizable compound.

In both of the first irradiation and the second irradiation, a voltage not lower than a threshold value is applied to the liquid crystal layer. Accordingly, the polymer layer has a shape that fits the inclination of the liquid crystal molecules changed by the voltage application, which enables to stabilize the pretilt alignment of the liquid crystal molecules and increase the inclination speed of liquid crystal molecules upon voltage application, that is, high-speed response can be achieved. Also, the alignment force is increased, and thus after images due to external pressure are less likely to appear.

Reflection on the ridged surface of the reflective stage includes “random reflection” with different reflection angles from an incidence angle. The reflective stage, having a ridged surface, can easily reflect light randomly on the surface of the reflective stage, and thus can introduce light into the reflective region.

As long as the liquid crystal display device of the present invention essentially includes these components, the structure of the liquid crystal display device of the present invention is not particularly limited by other components.

The irradiation is preferably performed by irradiating ultraviolet light having a peak wavelength of 365 nm at an illuminance of 4 to 8 mw/cm² for 60 to 300 seconds in terms of a wavelength of 313 nm, while applying a voltage not lower than a threshold value. Here, the desired tilt may not be achieved if the irradiation time is shorter than 60 seconds, whereas the tilt may be excessive and may damage the liquid crystal layer if the irradiation time is longer than 300 seconds.

The process for producing a semi-transmissive liquid crystal display device according to the present invention allows, with a small number of steps, sufficient polymerization reaction in each of the reflective region and the transmissive region in the liquid crystal layer, in production of a semi-transmissive liquid crystal display device.

### BRIEF DESCRIPTION OF DRAWINGS

FIG. 1 is a schematic cross-sectional view illustrating an example of a liquid crystal display device produced by the production process of the present invention.

FIG. 2 is a schematic cross-sectional view illustrating a state where PSA treatment is performed in the production process of a liquid crystal display device of a first embodiment.

FIG. 3 is for explaining a conventional process of applying a pretilt-angle providing technique with a polymerizable component to a semi-transmissive liquid crystal display device, and illustrates a state before light irradiation.

FIG. 4 is for explaining a conventional process of applying a pretilt-angle providing technique with a polymerizable component to a semi-transmissive liquid crystal display device, and illustrates a state after the light irradiation.

### MODES FOR CARRYING OUT THE INVENTION

The present invention will be described in more detail below with reference to the drawings, based on embodiments which, however, are not intended to limit the present invention.

### First Embodiment

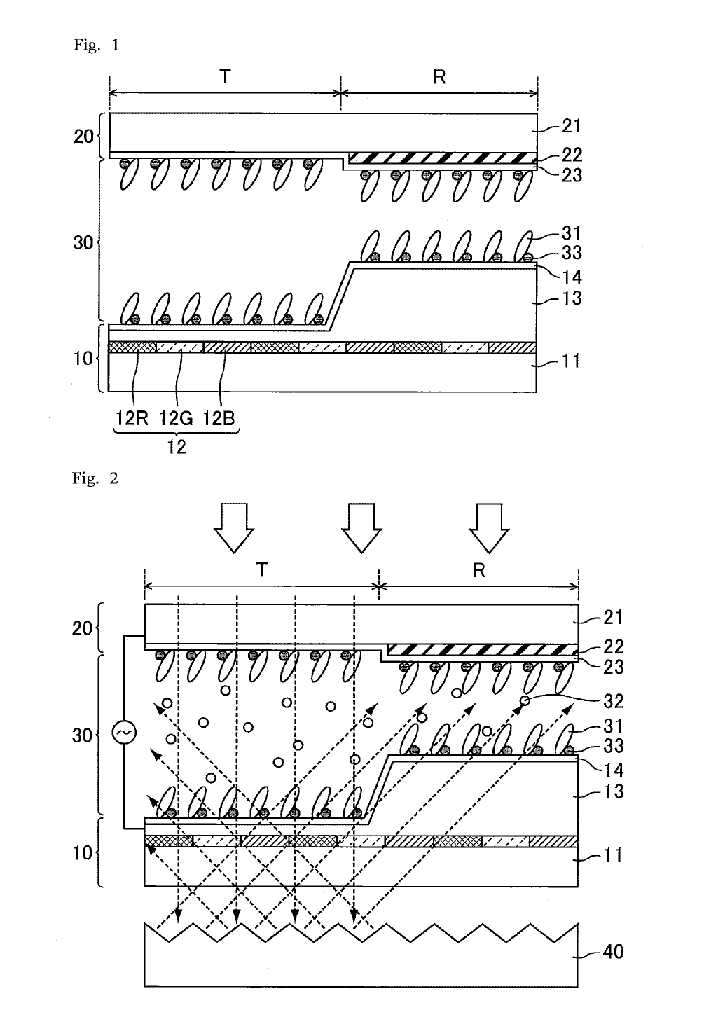

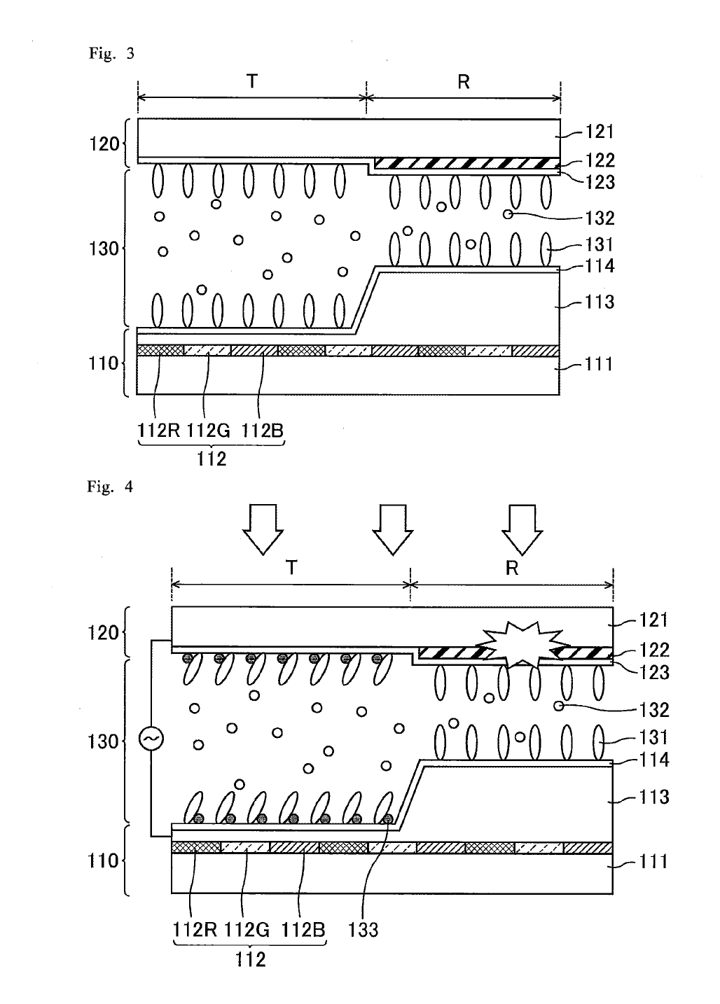

FIG. 1 is a schematic cross-sectional view illustrating an example of a liquid crystal display device produced by the production process of the present invention. As illustrated in FIG. 1, a liquid crystal display device according to the first embodiment includes a pair of substrates consisting of a color filter substrate 10 and an array substrate (counter substrate) 20, and a liquid crystal layer 30 sandwiched between the pair of substrates 10 and 20.

The color filter substrate 10 includes an insulating transparent substrate 11 made of a material such as glass and plastics. The transparent substrate 11 has, on the liquid crystal layer 30 side surface thereof, components such as a color filter (transparent colored layer) 12 provided with a red colored filter 12R, a green colored filter 12G, and a blue colored filter 12B; a multi-gap layer 13; a common electrode; and an alignment film 14.

The array substrate 20 has an insulating transparent substrate 21 made of a material such as glass and plastics. The transparent substrate 21 has, on the liquid crystal layer side, components such as a reflector 22, various wirings, TFTs, pixel electrodes, and an alignment film 23.

In the reflective region R of the liquid crystal display device of the first embodiment, the outdoor light enters the liquid crystal layer 30 through the color filter substrate 10, passes through the liquid crystal layer 30, and is reflected on the surface of the reflector 22. The light reflected on the surface of the reflector 22 passes through the liquid crystal layer 30 again, and is emitted to the outside as display light. Meanwhile, in the transmissive region T, the light from a light source such as a backlight enters the liquid crystal layer 30 from the backside of the array substrate 20, passes through the liquid crystal layer 30, and is emitted to the outside as display light.

Since the numbers of times the light passes through the liquid crystal layer 30 are different in the reflective region R and the transmissive region T as described above, the multi-gap layer 13 is provided in the reflective region R such that the distance for which the light travels in the liquid crystal layer is adjusted.

The color filter substrate 10 and the array substrate 20 in the liquid crystal display device of the first embodiment respectively have, on their surfaces, the alignment films 14 and 23 and polymer layers (hereinafter, also referred to as polymer sustained alignment (PSA) layers) 33 formed on the respective alignment films 14 and 23. The alignment films 14 and 23 are films capable of regularly inclining the liquid crystal molecules in the vicinity thereof in a certain direction, and include films having alignment treatment (e.g. rubbing treatment, photoalignment treatment) performed thereon and films having no alignment treatment performed thereon.

In the case of the liquid crystal display device of the first embodiment, the substrates 10 and 20 respectively have on their surfaces, the vertical alignment films 14 and 23 having no alignment treatment performed thereon and the polymer layers 33 formed on the respective vertical alignment films 14 and 23. Hence, as illustrated in FIG. 1, the liquid crystal molecules 31 in the vicinity of the surfaces of the color filter substrate 10 and the array substrate 20 are basically aligned in the vertical direction to the substrates 10 and 20 under no voltage application, and are sustained at a certain angle (1.0° to) 5.0°) from the above vertical direction. This state is unique to the structure in which the PSA layers 33 are formed on the respective vertical alignment films 14 and 23 through polymerization reaction under voltage application, and the pretilt of the liquid crystal molecules 31 can be fixed by strong alignment force.

Hereinafter, the process for producing the liquid crystal display device of the first embodiment is described in more detail.

First, the color filter substrate 10 including the color filter 12 in the transmissive region T and the reflective region R, and the array substrate 20 including the reflector 22 in the reflective region R are prepared. Each of the substrates 10 and 20 includes an insulating transparent substrate (e.g. glass, plastics) and various components formed on the transparent substrate.

The three colors for the color filter 12 of the color filter substrate are not limited to red (R), green (G), and blue (B), and may be any other colors. Further, four or more colors may be used with additional colors such as yellow and white. The thickness of the color filter may be 1.0 to 3.0 μm.

The reflector 22 of the array substrate 20 is made of a light blocking metal such as aluminum (Al), silver (Ag), and molybdenum (Mo), and is formed in the entire reflective region R.

The substrates 10 and 20 respectively have on the surfaces thereof the vertical alignment films 14 and 23 that are made of polyimide.

Next, a sealing material is applied to one of the substrates 10 and 20, and photospacers (columnar objects) are formed on the other of the substrates. The substrates are attached to each other to form a pair, and then a mixture of a liquid crystal material having negative dielectric anisotropy and a polymerizable compound is placed between the pair of substrates 10 and 20. The timing of placing the mixture is not limited as long as the mixture is eventually placed between the pair of substrates 10 and 20; for example, the step of placing the mixture may be performed before the substrates 10 and 20 are attached to each other to form a pair.

Next, the pair of substrates 10 and 20 having the mixture sandwiched therebetween is irradiated with UV light and heated such that the sealing material is cured. As a result, a liquid crystal cell is produced. The liquid crystal cell is then irradiated with ultraviolet light having a peak wavelength of 365 nm at an illuminance of about 5.7 mw/cm² (in terms of a wavelength of 313 nm), while a voltage not lower than a threshold value is applied to the liquid crystal cell. Thereby, polymerization reaction of the polymerizable compound is performed, so that the PSA layer 33 is formed on each of the vertical alignment films 14 and 23. Such production conditions enable to minimize damage to the liquid crystal molecules and to form a sufficient amount of the PSA layer 33.

To perform the ultraviolet light irradiation, a reflective stage is disposed on the backside of the color filter substrate. FIG. 2 is a schematic cross-sectional view illustrating a state where the PSA treatment is performed in the production process of the liquid crystal display device of the first embodiment.

As illustrated in FIG. 2, the light irradiation for the PSA treatment is performed from the array substrate 20 side. Light irradiation of the liquid crystal layer 30 initiates polymerization reaction of the polymerizable compound 32 in the liquid crystal layer 30 such that the polymerizable compound 32 is formed into the PSA layer 33 on the surface of each of the substrates 10 and 20. Since the PSA treatment is performed in the state where a voltage is applied to the liquid crystal layer 30, the PSA layer 33 is formed into a shape that fits the liquid crystal molecules the alignment of which has been changed.

Examples of the polymerizable compound 32 include compounds having a functional group of which the polymerization reaction proceeds by light irradiation. Examples of the functional group include acrylamide groups, methacrylamide groups, acrylate groups, methacrylate groups, vinyl groups, vinyloxy groups, and epoxy groups. The polymerizable functional group may have a substituent such as a halogen group and a methyl group as a part of its structure. In addition to such a polymerizable compound, compounds such as a polymerization initiator and a photosensitizer may be used so that the reaction rate of the polymerization increases.

Formation of the PSA layer 33 can be confirmed by observing the surfaces of the vertical alignment films 14 and 23 by a scanning electron microscope (SEM) or the like. One of the features of the structure of the PSA layer 33 is that, for example, the layer is a thin film having a thickness of about tens of nanometers, and is an aggregate constituted by particles each having a size of 500 nmφ or smaller.

The irradiated light passes through the liquid crystal layer 30 in the transmissive region T, but is blocked by the reflector 22 of the array substrate 20 in the reflective region R (first irradiation). However, in this embodiment, a reflective stage 40 is disposed on the backside of the color filter substrate 10 (the opposite side of the light incidence side), and thus the light having passed through the liquid crystal cell is reflected on the surface of the reflective stage 40 to pass through the liquid crystal cell again (second irradiation).

Also, the reflective stage 40 has a ridged surface, which causes the light to be randomly reflected on the surface of the reflective stage 40. Accordingly, even if light enters the surface of the reflective stage 40 vertically, the light can be introduced into the reflective region R. This structure enables to control the amount of UV light in the transmissive region T, and does not require long processing time as in the case of irradiation from the color filter substrate 10, and thereby the overall takt time for the processing is shortened.

The light irradiation direction in the PSA treatment according to the present embodiment is not limited to the vertical direction to the surface of the array substrate 20, and may be an oblique direction (e.g., direction at 45° from the substrate surface).

Examples of the material of the surface of the reflective stage 40 include aluminum (Al), silver (Ag), and gold (Au). Also, alloys such as a silver-palladium (Pd) alloy may be used. The reflective stage 40 may be a component entirely made of the above material, or may be formed by disposing, on a base component, a component made of the above material.

The reflective stage 40 may have a regularly ridged surface as long as it can scatter UV light, but preferably has a randomly ridged surface in terms of diffuse reflection. The ridges are preferably formed at intervals of not more than 10 μm, and are preferably not more than 1.0 μm in height. Examples of the process for forming such a ridged surface on the reflective stage include a process of applying a resin containing microgels to the surface and baking the applied resin; and a process of forming ridges on the resin through UV exposure (half exposure). After the formation of ridges, the above metallic material is applied to the ridged surface by vapor deposition or the like.

Lastly, films such as a polarizer and a λ/4 retarder, and external components such as a backlight are installed to the produced liquid crystal cell, whereby a liquid crystal display device is completed.

A polarizer is a component arranged on the surface of each of the color filter substrate and the array substrate on the side opposite to the liquid crystal layer, and has a feature of transmitting a light component oscillating in the same direction as that of the transmission axis.

A λ/4 retarder is a component providing a phase difference of λ/4 to the light passing therethrough, and is provided in the reflective region R. The retarder enables to prevent light from being blocked by the polarizer because of the different polarization states between the incidence light and the reflected light which have passed through the liquid crystal layer under voltage application.

Examples of the backlight include a light emitting diode (LED), a cold cathode fluorescent tube (CCFT), and an organic electro-luminescence (OEL). In the case of using an LED, multiple LEDs are arranged along the side face of the light guide plate.

The present application claims priority to Patent Application No. 2009-256331 filed in Japan on Nov. 9, 2009 under the Paris Convention and provisions of national law in a designated State, the entire contents of which are hereby incorporated by reference.

### EXPLANATION OF SYMBOLS

10, 110: Color filter substrate
11, 21, 111, 121: Transparent substrate
12, 112: Color filter
12R, 112R: Red colored filter
12G, 112G: Green colored filter
12B, 112B: Blue colored filter
13, 113: Multi-gap layer
14, 23, 114, 123: Alignment film
20, 120: Array substrate (counter substrate)
22, 122: Reflector
30, 130: Liquid crystal layer
31, 131: Liquid crystal molecule
32, 132: Polymerizable compound, monomer
33, 133: PSA layer (polymer layer)
40: Reflection stage
T: Transmissive region
R: Reflective region

1. A process for producing a liquid crystal display device that includes a pair of substrates consisting of a color filter substrate including a transparent colored layer and a counter substrate including a reflector, and a liquid crystal layer sandwiched by the pair of substrates, the process comprising
a first step of placing a liquid crystal material containing a polymerizable compound between the pair of substrates, and
a second step of forming, on a surface of each of the pair of substrates, a polymer layer resulting from polymerization of the polymerizable compound by irradiating the liquid crystal layer with light from the counter substrate side and from the color filter substrate side while applying a voltage not lower than a threshold value to the liquid crystal layer,
the irradiation from the color filter substrate side being performed by causing light having passed through the pair of substrates to be reflected on a ridged surface of a reflective stage that is arranged on an outer side of the color filter substrate.

2. The process according to claim 1,
wherein the irradiation is performed by irradiating ultraviolet light having a peak wavelength of 365 nm at an illuminance of 4 to 8 mw/cm² for 60 to 300 seconds in terms of a wavelength of 313 nm, while applying a voltage not lower than a threshold value.
